(19) United States
(12) Patent Application Publication
(10) Pub. No.: US 2025/0095362 A1
(43) Pub. Date: Mar. 20, 2025

(54) MACHINE LEARNING TO DETECT FAKE VIDEOS

(71) Applicant: International Business Machines Corporation, Armonk, NY (US)

(72) Inventors: Mikael HILLBORG, Umeå (SE); Shaheer Jamal SYED, Stockholm (SE)

(21) Appl. No.: 18/467,160

(22) Filed: Sep. 14, 2023

(51) Int. Cl. G06V 20/40; G06F 40/279

(52) U.S. Cl. CPC G06V 20/41; G06F 40/279; G06V 20/46

(57) ABSTRACT

Method and apparatus for detection of fake videos. A statement asserting that a video is fake is accessed. One or more characteristics of the statement is identified, where the one or more characteristics comprises at least one of source information for the video, source information for an reference video, or one or more timestamps in the video. Consistency checks between audio and video of the video is performed. Video features of the video is examined to detect modifications. Overlapping clips between the video and the reference video is identified. The video is determined to be fake based at least in part on the one or more characteristics of the statement, the consistency checks, the video features, and the identified overlapping clips.

### BACKGROUND

The present invention relates to fake video detection, and, more specifically, to validating the authenticity of a video based on audio and visual analyses.

Technological advancements have significantly simplified the process of altering videos. These alterations can take many forms, including simple edits such as adding or removing clips, rearranging the order of scenes, or changing the audio track of a video to influence its perceived meaning, as well as more complex manipulations such as swapping the face or voice of a person in the original video with another person's face or voice, or even generating new movements and expressions that blend seamlessly with the replaced person's actions. Consequently, there is a rising trend for individuals manipulating videos and uploading them online. The fake or altered videos are used for various purposes, most often with malicious intent. For example, these altered videos may serve to propagate false rumors, misrepresent public figures or organizations, mislead consumers about products or services, or even influence political decisions.

### SUMMARY

One embodiment presented in this disclosure provides a method, including accessing a statement asserting that a video is fake, identifying one or more characteristics of the statement, where the one or more characteristics comprises at least one of source information for the video, source information for an reference video, or one or more timestamps in the video, performing consistency checks between audio and video of the video, examining video features of the video to detect modifications, identifying overlapping clips between the video and the reference video, and determining that the video is fake based at least in part on the one or more characteristics of the statement, the consistency checks, the video features, and the identified overlapping clips.

Other embodiments in this disclosure provide non-transitory computer-readable mediums containing computer program code that, when executed by operation of one or more computer processors, performs operations in accordance with one or more of the above methods, as well as systems comprising one or more computer processors and one or more memories containing one or more programs which, when executed by the one or more computer processors, performs an operation in accordance with one or more of the above methods.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example computing environment for the execution of at least some of the computer code involved in performing the inventive methods.

FIG. 2 depicts an example environment in which embodiments of the present disclosure may be implemented.

FIGS. 3A-3B depict an example of workflow for fake video detection, according to some embodiments of the present disclosure.

FIG. 4 depicts an example method for authenticity detection in user-identified fake videos, according to some embodiments of the present disclosure.

FIG. 5 is a flow diagram depicting an example method for validating the authenticity of videos flagged as fake by users, according to some embodiments of the present disclosure.

FIG. 6 depicts an example computing system for fake video detection, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments herein describe a method or system for validating the authenticity of videos flagged as potentially fake, misleading, or inauthentic by online users. As used herein, “fake,” “misleading,” or “inauthentic” video may refer to a video that misrepresents or does not accurately portray the original video footage, and/or a video that misrepresents reality (e.g., a video that is not created based on a reference video, such as when the video is entirely computer generated). The terms “fake,” “misleading,” and “inauthentic” may apply to any video where the content has been altered from its original footage to represent information that is inaccurate and/or misleading. As used herein, the “reference,” or “purportedly original” video may refer to a video that is identified as a purportedly original source of the “fake,” “misleading,” or “inauthentic” video through web crawling and natural language analysis. The video authenticity validation relies on a weighted multi-objective function that combines results from a variety of audio and visual analyses, which may include, for example, audio/visual consistency checks, examinations of video properties, traces of reference videos, and detections of overlapping clips. In one embodiment, online users may pinpoint specific cue-points in the video suspected of being manipulated. As such, the audio/visual consistency checks may be synchronized with these identified cue-points. For example, the system may compare the audio syllables extracted at these cue-points with their adjacent video frames to check if noticeable discrepancies exist. In some embodiments, video property analyses may also be synchronized with these identified cue-points. For example, the system may analyze the video properties at these cue-points to detect potential artificial manipulations. In some embodiments, machine learning models may be trained and deployed to perform the audio/visual consistency checks and video property examinations. In some embodiments, machine learning models may be deployed using a variety of audio and visual analyses as inputs to predict the authenticity of videos. In some embodiments, the various audio and visual analyses (e.g., the audio/visual consistency check, video property examination, and overlapping clip detection, etc.) may be applied to the entire video.

The present disclosure serves to alert the public when they access knowledge or content that may be biased or manipulated, thereby preserving the integrity of the accessed information.

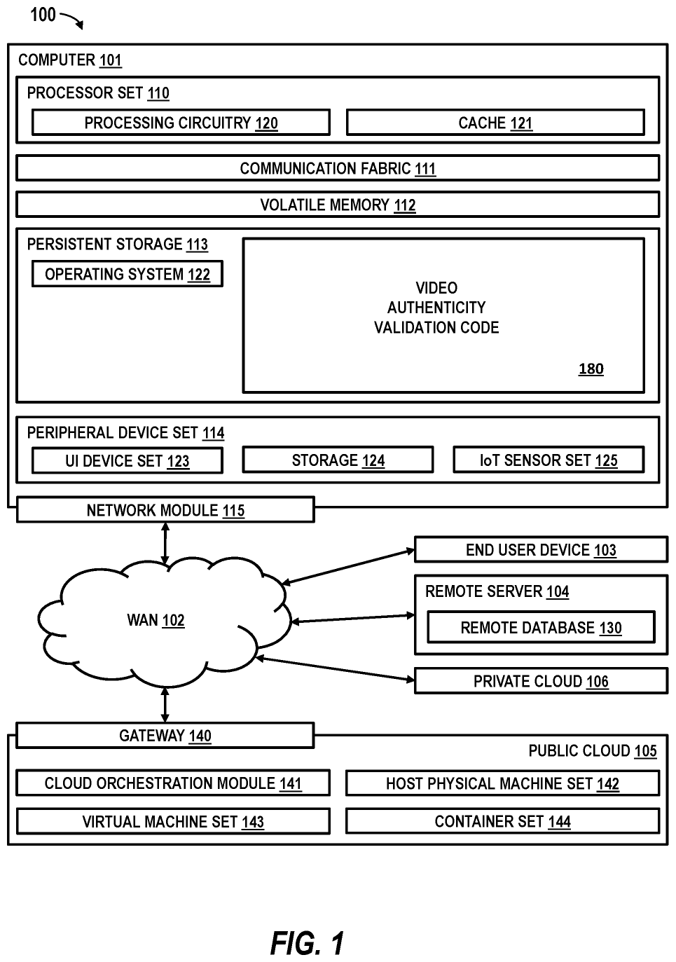

FIG. 1 depicts an example computing environment 100 for the execution of at least some of the computer code involved in performing the inventive methods.

Computing environment 100 contains an example of an environment for the execution of at least some of the computer code involved in performing the inventive methods, such as Video Authenticity Validation Code 180. In addition to Video Authenticity Validation Code 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and Video Authenticity Validation Code 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in Video Authenticity Validation Code 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in Video Authenticity Validation Code 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

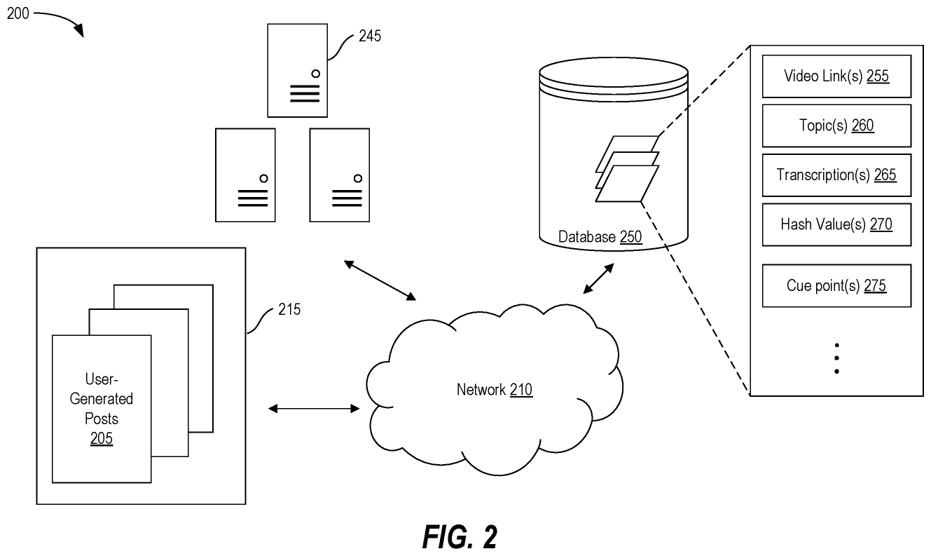

FIG. 2 depicts an example environment 200 in which embodiments of the present disclosure may be implemented. In the illustrated example, the environment 200 includes one or more servers 245, a database 250, and a digital library 215. In some embodiments, one or more of the illustrated devices may be a physical device or system. In other embodiments, one or more of the illustrated devices may be implemented using virtual devices, and/or across a number of devices.

In the illustrated example, the digital library 215, the database 250, and the servers 245 are remote from each other and communicatively coupled to each other via a network 210. That is, the servers 245, the database 250, and the digital library 215 may each be implemented using discrete hardware systems. The network 210 may include or correspond to a wide area network (WAN), a local area network (LAN), the Internet, an intranet, or any combination of suitable communication medium that may be available, and may include wired, wireless, or a combination of wired and wireless links. In some embodiments, the servers 245, the database 250, and the digital library 215 may be local to each other (e.g., within the same local network and/or the same hardware system), and communicate with one another using any appropriate local communication medium, such as a local area network (LAN) (including a wireless local area network (WLAN)), hardwire, wireless link, or intranet, etc.

In the illustrated example, the digital library 215 comprises a plurality of user-generated posts 205. The user-generated posts 205 may refer to any form of content authored and posted by users on online platforms, such as social media posts, comments, reviews, blogs, and the like. In some embodiments, the user-generated posts 205 comprise textual data (e.g., written posts). In some embodiments, the user-generated posts 205 may additionally or alternatively comprise other forms of data, such as audio recordings, video recordings, and the like. The user-generated posts 205 may include opinions and discussions made by individual online users, and may be used to challenge the authenticity of a video shared or uploaded online. For example, a user may comment directly below a shared video, asserting the video content is fake or manipulated. The user may also pinpoint certain cue-points in the timeline of the shared video that she believes have been manipulated or edited. In some embodiments, the user-generated posts 205 may include a link that leads to a video that the user believes is original and unedited (also referred to in some embodiments as a reference video) (e.g., to indicate the original or unmodified source video). In some embodiments, the user-generated posts 205 may include tags (e.g., hashtags or keyword tags) that serve to describe the content of each post.

In the illustrated example, the servers 245 are capable of accessing, retrieving, and examining the user-generated posts stored in the digital library 215. The servers 245 may analyze specific user-generated posts by applying a content analysis classifier, which allows the servers 245 to determine if the post includes any assertions that dispute the credibility of a shared video. If such assertions are found, the servers 245 may then proceed to further analyze the text from the post, the disputed video, and, in some embodiments, a reference, unedited video to determine whether the disputed video is fake.

In the illustrated example, the servers 245 may store their generated results or analyses in the database 250. For example, the computing environment 100 may extract key entities by processing the text of a post. These extracted key entities may include a web link of the shared video (e.g., a first video link 255), a web link leading to a reference video (e.g., a second video link 255), the topics or tags (included in the post and/or generated using natural language processing or other techniques) (e.g., 260), and any timestamps or cue-points (e.g., 275) within the disputed video that the post has identified as having been edited. The servers 245 may also convert the audible content of the shared video into written text (e.g., transcriptions(s) 265) and store it in the database 250. Additionally, the servers 245 may produce a fingerprint or signature (also referred to in some aspects as a sequence of hash values) for the shared video and/or the reference video using a hash function. The computing system may then store these fingerprints or signatures (e.g., sequences of hash values 270) within the database 250.

In some embodiments, the servers 245 may extract and evaluate the data from database 250, as discussed in more detail below, to perform various advanced audio and visual analyses, in order to validate the credibility of a shared video.

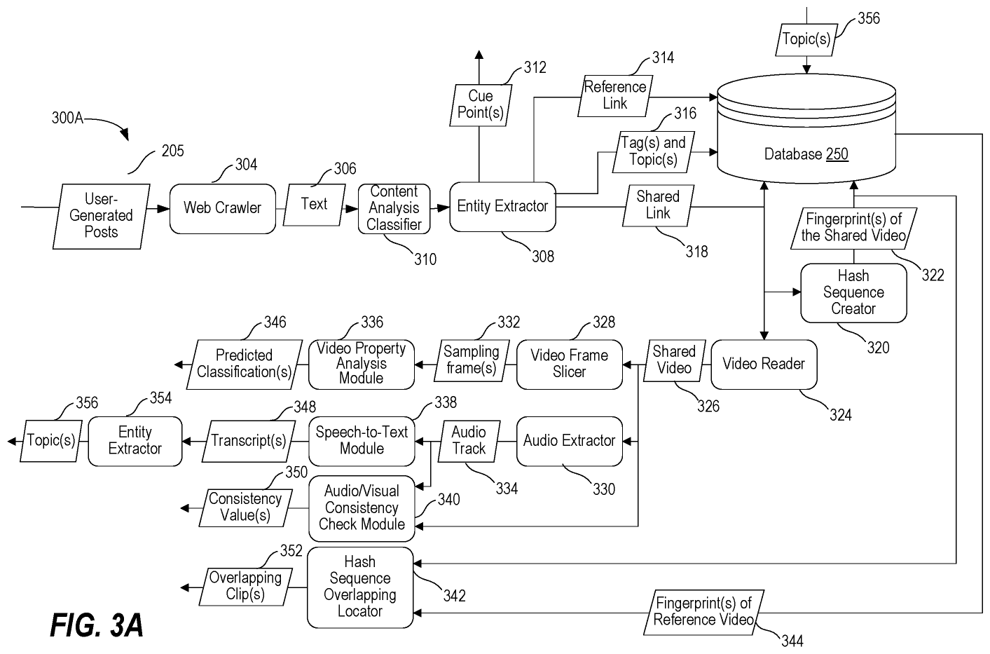

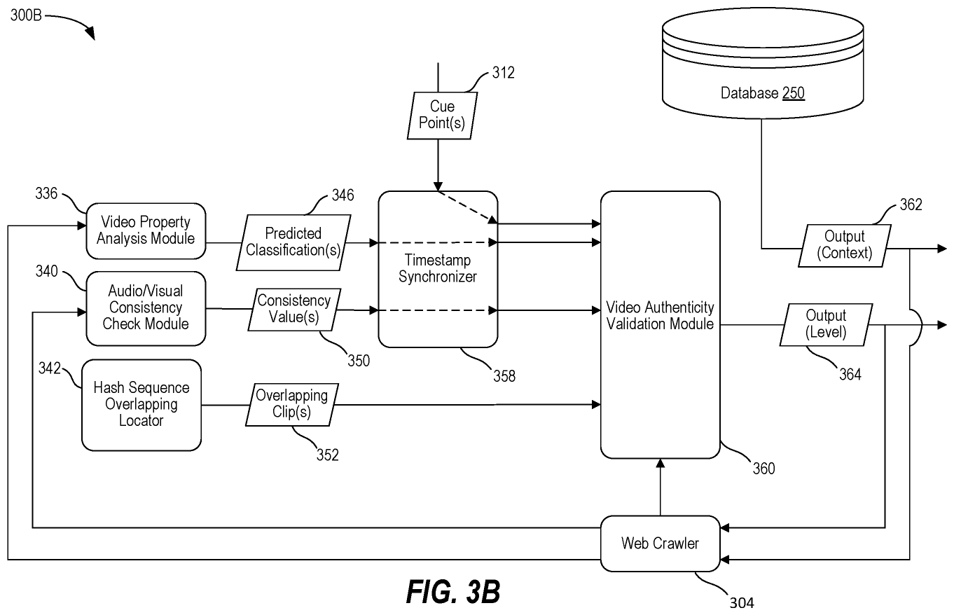

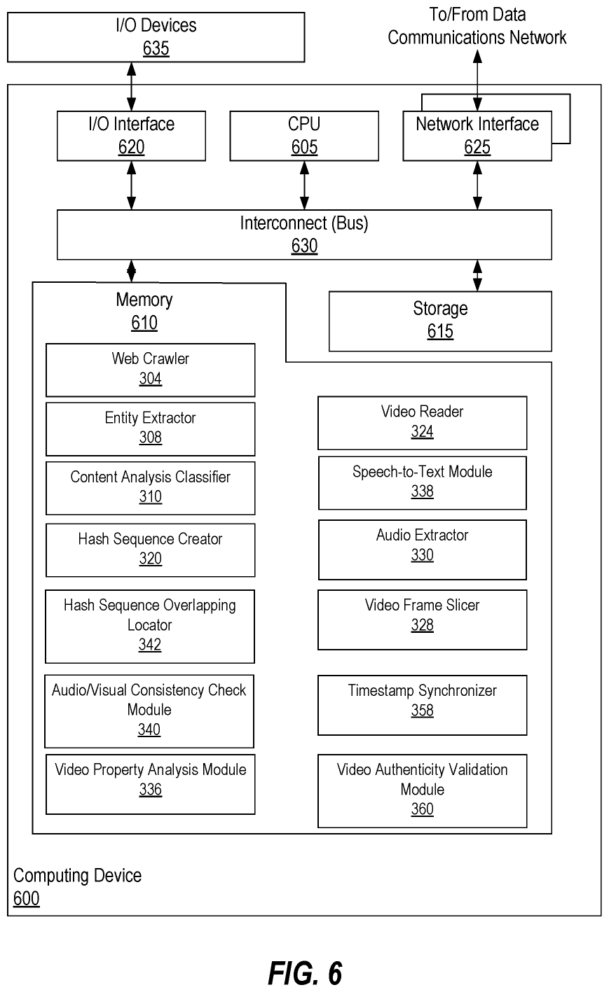

FIGS. 3A-3B depict an example of workflow for fake video detection, according to some embodiments of the present disclosure. In some embodiments, the workflow 300A of FIG. 3A and workflow 300B of FIG. 3B (collectively, forming a workflow 300) may be performed by one or more computing devices, such as the computer 101 as illustrated in FIG. 1, the server(s) 245 as illustrated in FIG. 2, and/or the computing system 600 as illustrated in FIG. 6. Though depicted as discrete components for conceptual clarity, in some embodiments, the operations of the depicted components (and others not depicted) may be combined or distributed across any number and variety of components, and may be implemented using hardware, software, or a combination of hardware and software.

In the illustrated example, a web crawler 304 is used to systematically browse and search through user-generated posts 205 across various online platforms. The user-generated posts 205 may encompass a variety of content types shared by user online. The user-generated posts 205 may include, but is not limited to, social media posts, remarks, comments, reviews, blogs, and other similar forms of online interaction. The web crawler 304 may scan and extract the text 306 of user-generated posts 205, and process this information through a content analysis classifier 310. In some embodiments, the content analysis classifier is a binary text classifier that is trained to identify whether a post contains assertions that dispute the credibility of a shared video. The content analysis classifier 310 may take various features as inputs, such as specific keywords, phrases, or sentiment patterns, to classify each user-generated post 205 into one of two categories: the posts that do challenge the authenticity of a shared video, and the posts that do not.

Once the content analysis classifier 310 determines that a specific user-generated post contains assertions of a shared video being fake, an entity extraction operation is initiated. In the illustrated example, the text of the user-generated post is provided to the entity extractor 308. The entity extractor 308 processes the text of the post to identify and extract key entities. In some embodiments, besides the statements claiming that a shared video is fake, as stated above, the user-generated post may also include a link leading to a video that the user believes is original and unedited (also referred to in some embodiments as a reference video), and/or cue-points in the timeline of the shared video that the user believes have been manipulated (and/or cue-points in the reference video that allegedly correspond to the purportedly fake video). When processing such type of user-generated posts, the entity extractor 308 may generate key entities such as a link of the shared video 318 (e.g., a URL link), a link of the reference video 314 (e.g., a URL link), and the indicated cue-point(s) 312. In some embodiments, the extracted entities may also include hashtags or topics 316 associated with the post. The extracted key entities and their respective values (e.g., reference link 314, tags and topics 316, shared link 318) are stored in the database 250, and can be used to further analysis of the video's authenticity.

In the illustrated example, the shared link 318 (the link of the shared or purportedly fake video) is then provided to a hash sequence creator 320, which generates a unique fingerprint or signature 322 of all or a portion of the shared video using a hash function. In some embodiments, the shared video is first processed to create a set of sampling frames at a defined interval. A hashing algorithm is then applied to each of these sampling frames, generating a sequence of hash values. These hash values collectively form a signature or fingerprint of the shared video (or a portion thereof), which can be used for comparison against the signatures of other videos to assess similarity. In some embodiments, the hash function utilizes a perceptual hashing algorithm, which is designed to generate similar hash values for images or frames that are similar. In the context of video comparison, if two videos are very similar (or if one is slightly distorted compared to the other), their perceptual fingerprints generated by the same perceptual hashing algorithm will also be very similar.

As illustrated, the fingerprint of the reference video is retrieved from the database 250 by the hash sequence overlapping locator 342. By comparing the fingerprints of the reference video 344 and the shared video 322, the hashing sequence overlapping locator may identify the overlapping clips 352, even if the shared video has been slightly modified. In some embodiments, the identification of overlapping clips may be achieved by comparing the similarity between the perceptual hash values of each sampling frame in the shared video with the hash values of frames in the reference video. In some embodiments, for each pair of perceptual frames, the similarity between two hash values may be calculated using a distance metric, such as cosine similarity or Euclidean distance. If the similarity is above a defined threshold, the hash sequence overlapping locator 342 may determine the frames contain very similar content and therefore may come from the same source. The process may be repeated for each pair of perceptual frames throughout the duration of the videos. If a clip of the shared video comprising multiple frames and that their similarities are consistently above the threshold, the hash sequence overlapping locator 342 may identify the clip of the shared video as an overlapping clip 352 with the reference video.

In the illustrated example, the link 318 (e.g., URL) to the shared video is provided to a video reader 324, which accesses and retrieves the shared video 326 from the specified link. The shared video 326 is then passed to an audio extractor 330.

The audio extractor 330, upon receiving the shared video 326, starts an audio ripping process to extract the audio track 334 embedded within the video. The extracted audio track 334 is then provided to a speech-to-text module 338 and an audio/visual consistency check module 340. The speech-to-text module 338, upon receiving the audio track 334, begins to convert the speech (if any) within the audio track 334 into corresponding textual data. As illustrated, the output of the speech-to-text module 338 is a transcription 348 of the speech in the shared video, which can be used for further keyword extraction and content analysis.

In the illustrated example, the generated transcript 348 of the shared video is then passed to another entity extractor 354, which identifies and extracts the topics 356 that have been discussed in the shared video. The identified topics 356 are then saved in the database 250, and may be used to provide further context and understanding of the content of the video. In some embodiments, the identified topics 356 may be saved together with the fingerprint or signature (also referred to in some aspects as a sequence of hash values) of the shared video. As such, the database 250 may categorize, search, and manage the videos more efficiently. For conceptual clarity, in the illustrated example, the entity extractor 354 for the transcripts 348 and the entity extractor 308 for the user-generated posts 205 are depicted as two discrete components. In some embodiments, the transcripts 348 and user-generated posts 205 may be processed by a single entity extractor.

In the illustrated example, an audio/visual consistency check is initiated when the extracted audio track 334 and the shared video are provided to the audio/visual consistency check module 340. In one embodiment, the audio/visual consistency check module 340 may first process the audio track 334 to extract syllables in the speech (if any) of the shared video. The audio/visual consistency check module 340 may also identify the time points at which each syllable is spoken and generate a timeline of syllables in the audio track. After the syllables are extracted, the audio/visual consistency check module 340 may correlate the time points with the video track and extract video frames adjacent to (or corresponding with) each identified time point. The audio/visual consistency check module 340 may then compare each of the extracted syllables with their adjacent (or corresponding) video frame(s) to check the audio/visual consistency of the shared video (e.g., to determine whether the speaker's mouth appears to be speaking the corresponding syllable). In some embodiments, the comparison between the extracted syllables and their corresponding video frames may be performed using machine learning models. Based on the comparison, the audio/visual consistency check module 340 may generate a consistency value 350 for each extracted syllable within the audio track. In some embodiments, the consistency value 350 may be a numerical score that indicates the degree of consistency between an audio syllable and its adjacent (or corresponding) video frame(s). In other embodiments, the consistency value 350 may be a binary value indicating whether the audio and video are consistent. The generated consistency values 350 may be mapped onto the timeline of syllables, creating a visual representation of the consistency throughout the duration of the video.

As illustrated, a video frame slicer 328 also receives the shared video 326 and processes it to generate sampling frames at a defined interval. The generated sampling frames 332 are then passed to a video property analysis module 336. The video property analysis module 336 analyzes each sampling frame to determine whether it has been modified. For example, in one embodiment, the video property analysis module 336 may analyze the computer vision (CV) properties of each frame to determine whether artificial modifications exist. The CV properties may include pixilation, shadows, colors, edges, textures, or other characteristics that are indicative of a video's quality or potential modifications. For each frame, a numerical value for each CV property may be identified or generated to represent the intensity or extent of the property in that frame. The CV properties and their corresponding values for each frame are then fed into machine learning model(s) for modification detection. In one embodiment, the output (e.g., predicted classifications 346) of the machine learning model(s) may be a binary classification, indicating whether a frame has been manipulated. In some embodiments, the output (e.g., predicted classifications 346) of the machine learning model(s) may be a numeral value that indicates the degree of confidence that a certain frame has been manipulated.

In some embodiments, the CV properties and their corresponding values for each frame may be passed by a lowpass filter to remove frames with high frequency noise or fluctuations in the CV properties of the shared video (also referred to in some aspects as occasional, fleeting glitches in the shared video). By applying the lowpass filter, the system may avoid false positive results in the modification detection process.

In some embodiments, the machine learning model for modification detection is an unsupervised frame classifier that detects groups of frames that are different from the rest, therefore marking the detected groups of frames as manipulated. In some embodiments, the machine learning model is a supervised machine learning model that is trained on labeled data that comprises both manipulated and unmanipulated frames. The machine learning model may learn patterns of manipulation automatically by processing the dataset. Once the training is completed, the machine learning model may be tuned and tested on unseen new datasets to further improve its accuracy.

In the illustrated example, the predicted classifications 346, the consistency values 350 and the detected overlapping clips 352 are then synchronized and considered together to validate the authenticity of the shared video, as depicted in FIG. 3B.

As shown in FIG. 3B, the predicted classifications for frames 346, and the consistency values 350 are synchronized in time with the cue-points 312 indicated within user-generated posts at the timestamp synchronizer 358. The outputs of the timestamp synchronizer 358, such as the predicted classifications for frames 346 and the consistency values 350, which have both been synchronized, are then sent to a video authenticity validation module 360, along with the identified overlapping clips 352 and the cue-points 312. The video authenticity validation module 360 may employ a multi-objective function to incorporate and balance the multiple types of inputs to generate a final output. For example, in one embodiment, the video authenticity validation module 360 may assign a specific weight to each type of input, which may be determined based on how important each source of information should be in influencing the final decision. In some embodiments, when no consistency values could be obtained around the cue-points, possibly caused by the silence around the cue-points, the video authenticity validation module 360 may reduce the weight assigned to the audio/visual consistency stream. In another embodiment, when it is not possible to obtain confidence values for frame classification around the cue-points, the weight assigned to the predicted classification stream may be reduced.

In one embodiment, the output (level) 364 of the video authenticity validation module 360 may be a binary classification, where the video authenticity validation module 360 summarizes the four streams (including the cue-points 312, the predicted classifications 346, the consistency values 350, and the overlapping clips 352) with their assigned weights, and compares the result with a defined threshold. If it is above the defined threshold, the video authenticity validation module 360 may determine or infer that the shared video is fake. Additionally, the video authenticity validation module 360 may further retrieve the shared link 318 of the shared video, as well as its associated tags and topics (316 and/or 356) from the database 250 to create an output (context) 362. Both types of outputs are then returned in a feedback loop to the web crawler 304, which uses the information to determine whether another crawling of the shared video should be performed to check if more references appear. For example, if the shared video under the shared link is determined by the video authenticity validation module 360 to be authentic, but a new crawling search turns up additional user-generated posts disputing the shared video of being fake, the system may run the validation process again, lowering the thresholds for the audio/visual consistency check and the video modification detection.

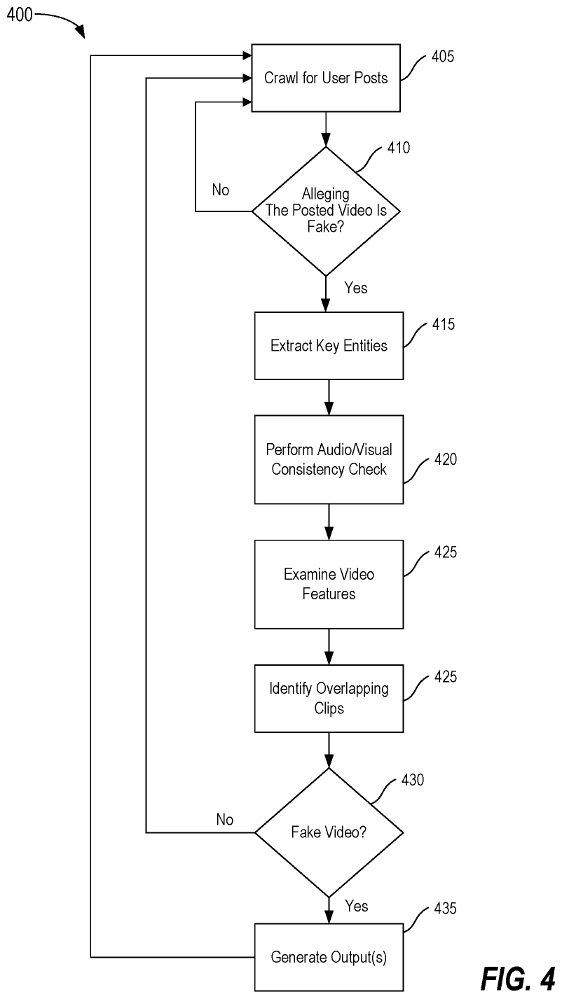

FIG. 4 depicts an example method for authenticity detection in user-identified fake videos, according to some embodiments of the present disclosure. In some embodiments, the method 400 may be performed by a computing system (e.g., 600 of FIG. 6) in a device, such as the computer 101 as shown in FIG. 1, or the server(s) 245 as shown in FIG. 2.

The method 400 begins at block 405, where a computing system crawls user-generated posts across the network. The user-generated posts may include any form of content written and posted by users online, including but not limited to social media posts, comments, reviews, blog entries, and the like. The computing system may systematically browse various platforms and websites to locate user-generated posts, and automatically extract information from these posts. In some embodiments, the operations for crawling user-generated posts are performed by a web crawler (e.g., 304 of FIGS. 3A and 6).

At block 410, the computing system analyzes the content of a specific user-generated post to determine whether it alleges that a shared video (or a video posted online) is fake. If the computing system determines the present post contains assertions that challenge the credibility of a shared video, the computing system categorizes the post as a candidate for further analysis, and proceeds to block 415. Otherwise, the system returns to block 405, where it continues to search for a new post. In some embodiments, the operations for determining whether a post challenges the credibility of a shared video are performed by a content analysis classifier (e.g., 310 of FIGS. 3A and 6).

At block 415, the computing system extracts key entities from the user-generated post. The key entities may include a link of the shared video (e.g., a URL link), a link of a reference video (e.g., a URL link), and/or the cue-point(s) indicated within the post. In some embodiments, the extracted entities may also include hashtags or topics associated with the post. The extracted key entities and their respective values may be saved in local storage or a remote database for further analysis of the authenticity of the shared video. In some embodiments, the operations for extracting key entities from user-generated posts are performed by an entity extractor (e.g., 308 of FIGS. 3A and 6).

At block 420, the computing system performs audio/visual consistency checks on the shared video. The computing system may extract the audio track of the shared video using an audio extractor (e.g., 330 of FIGS. 3A and 6), and then transcribe the audible content within the audio track into textual data using a speech-to-text module (e.g., 338 of FIGS. 3A and 6). Based on the extracted audio track and its respective transcription(s), the computing system may identify the syllables in the shared video. The identified syllables may be arranged according to the timeline of the shared video and compared with each of their adjacent (or corresponding) video frames, respectively. In some embodiments, a consistency value is generated for each syllable, indicating the degree of consistency between a specific syllable and its adjacent (or corresponding) video frames. The consistency values collectively may be mapped onto the timeline of the video, creating a visual representation of the consistency throughout the duration of the video. In some embodiments, the audio/visual consistency checks are performed by an audio/visual consistency check module (e.g., 340 of FIGS. 3A and 6).

At block 425, the computing system examines the video features of the shared video to determine whether it has been manipulated. The video features may refer to the CV properties that are indicative of a video's quality or potential modifications. The CV properties may include pixilation, shadows, colors, edges, and/or textures. In some embodiments, the computing system may examine every frame of the shared video to determine whether it has been manipulated or edited. In some embodiments, the computing system may create a set of sampling frames for the shared video based on a defined interval, and the system may then examine each sampling frame to determine whether it has been mod manipulated. In some embodiments, the operations for examining video features are performed by a video property analysis module (e.g., 336 of FIGS. 3A and 6).

At block 425, the computing system identifies the overlapping clips between the shared video and a video that the user believes is original and unedited (also referred to in some embodiments as a reference video). In some embodiments, the reference video is identified by the user in his social media post. In some embodiments, the reference video is identified by the database (e.g., 250 of FIG. 2) based on the topics and tags associated with the shared video. In one embodiment, the computing system identifies the overlapping clips by comparing the similarity between the fingerprints of the reference video and the shared video. For example, the computing system may hash both the shared video and the reference video using the same perceptual hashing algorithm. After that, the system may compare the hash values of each frame within the shared video with hash values of frames from other videos reflected in the database. Based on the similarity between each pair of frames, the system may determine whether the content in each pair of frames is similar and therefore may come from the same source. If a clip of the shared video that comprises multiple frames and their similarities are consistently above a defined threshold, the system may identify the clip of the shared video as an overlapping clip with the reference video. In some embodiments, the operations for identifying overlapping clips are performed by a hash sequence overlapping locator (e.g., 342 of FIGS. 3A and 6).

At block 430, the computing system summarizes the data from four different streams to determine whether the shared video is fake. The four streams may include the cue-point(s) indicated within a user-generated post, the predicted classifications generated based on examining video features, the audio/visual consistency values, and the identified overlapping clips. In some embodiments, the computing system may incorporate and balance the four streams by assigning a specific weight to each stream, and generate a final score based on the four streams along with their assigned weights. If it is determined that the final score does not pass a defined threshold, the method returns to block 405, where the computing system continues crawling for new user-generated posts.

If it is determined that the final score passes a defined threshold, the method then proceeds to block 435, where the computing system generates an output indicating its prediction that the shared video is fake. In some embodiments, besides the indication that the shared video is fake, the output(s) may further comprise the shared link (e.g., 318 of FIG. 3A) of the shared video and/or of the reference video, as well as its associated tags and topics (e.g., 316 and/or 356 of FIG. 3A). The method then returns to block 405, where the computing system loops the output(s) back to the web crawler (e.g., 304 of FIG. 3B) to determine whether additional searches of the shared video should be performed to check if more references appear.

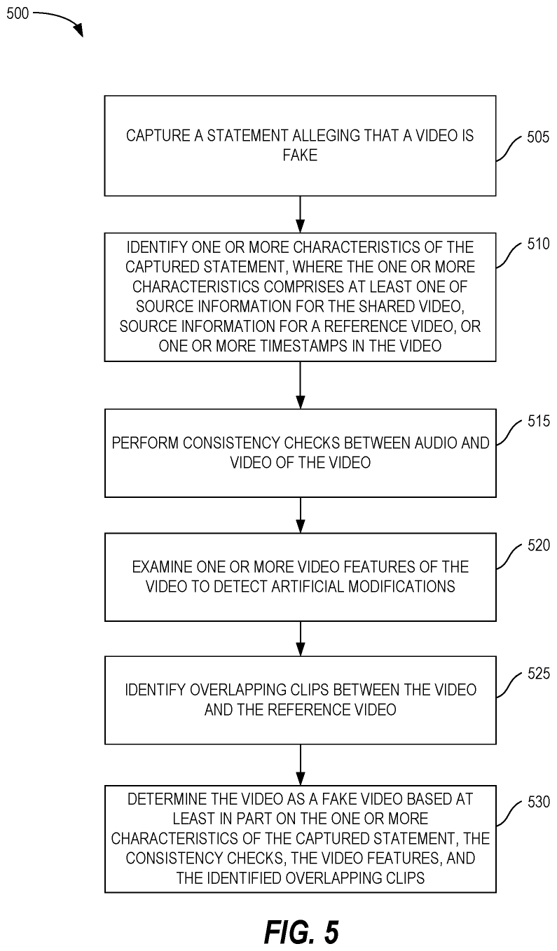

FIG. 5 is a flow diagram depicting an example method for validating the authenticity of videos flagged as fake by users, according to some embodiments of the present disclosure.

The method 500 begins at block 505, where a system (e.g., the computing system 600 of FIG. 6) captures/accesses a statement (e.g., user-generated post 205 of FIG. 3A) alleging that a shared video is fake. In some embodiments, the process of capturing/accessing a statement alleging that a shared video is fake may further comprise analyzing texts (e.g., 306 of FIG. 3A) within the statement using a binary classifier (e.g., 310 of FIG. 3A).

At block 510, the system identifies one or more characteristics of the captured statement (e.g., user-generated post 205 of FIG. 3A). The one or more characteristics comprise at least one of the following: source information for the shared video (e.g., shared link 318 of FIG. 3A), source information for a reference video (e.g., reference link 314 of FIG. 3A), or one or more timestamps (e.g., cue-points 312 of FIG. 3A) in the shared video. In some embodiments, the statement further comprises one or more tags (e.g., tags and topics 316 of FIG. 3A) describing the contents of the shared video.

At block 515, the system performs consistency checks between the audio and video of the shared video. In some embodiments, the system may extract the audio track (e.g., 334 of FIG. 3A) of the shared video; convert the audio track into a sequence of syllables, where the sequence of syllables comprises a plurality of syllables that are spoken at different time points within the shared video; process the shared video to create a plurality of sampling frames, where each respective sampling frame is captured at a time point that a respective syllable is spoken; and compare each respective syllable with each respective sampling frame to generate a plurality of consistency values (e.g., 350 of FIG. 3A). In some embodiments, the plurality of consistency values (e.g., 350 of FIG. 3A) is mapped onto a timeline, with each respective value representing a degree of consistency between the audio and video of the shared video at a time point that a respective syllable is spoken.

At block 520, the system examines one or more video features of the shared video to detect modifications. In some embodiments, the system may process the shared video to create sampling frames (e.g., 332 of FIG. 3A) at a defined interval; analyze each of the sampling frames to extract the one or more video features using one or more image processing algorithms, where the one or more video features comprise at least one of (i) pixilation; (ii) shadows; (iii) colors; (iv) edges; (iv) textures; and determine the shared video has been manipulated based on the one or more video features using a machine learning model. In some embodiments, the system may pass the outputs of the one or more image processing algorithms into a lowpass filter to remove high frequency noise in the extracted one or more video features.

At block 525, the system identifies overlapping clips (e.g., 352 of FIG. 3A) between the shared video and the reference video. In some embodiments, the system may process the shared video to create sampling frames at a defined interval, hash the sampling frames to generate a signature for the shared video, retrieve a signature for the reference video from a database, and compare the signature for the shared video with the signature for the reference video to identify the overlapping clips between the shared video and reference video.

At block 530, the system determines that the shared video is fake based at least in part on the one or more characteristics of the captured statement (e.g., shared link 318, reference link 314, cue-points 312, tags and topics 316 of FIG. 3A), the consistency checks (e.g., 350 of FIG. 3A), the video features (e.g., 346 of FIG. 3A), and the identified overlapping clips (e.g., 352 of FIG. 3A).

FIG. 6 depicts an example computing system for fake video detection, according to some embodiments of the present disclosure. Although depicted as a physical device, in embodiments, the computing system 600 may be implemented using virtual device(s), and/or across a number of devices (e.g., in a cloud environment). The computing system 600 can be embodied as any computing device, such as the computer 101 as illustrated in FIG. 1, or the server(s) 245 as illustrated in FIG. 2.

As illustrated, the computing system 600 includes a CPU 605, memory 610, storage 615, a network interface 625, and one or more I/O interfaces 620. In the illustrated embodiment, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally included to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the computing system 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630.

In the illustrated embodiment, the memory 610 includes a web crawler 304, an entity extractor 308, a content analysis classifier 310, a hash sequence creator 320, a hash sequence overlapping locator 342, an audio/visual consistency check module 340, a video property analysis module 336, a video reader 324, a speech-to-text module 338, an audio extractor 330, a video frame slicer 328, a timestamp synchronizer 358, and a video authenticity validation module 360.

Although depicted as a discrete component for conceptual clarity, in some embodiments, the operations of the depicted component (and others not illustrated) may be combined or distributed across any number of components. Further, although depicted as software residing in memory 610, in some embodiments, the operations of the depicted components (and others not illustrated) may be implemented using hardware, software, or a combination of hardware and software.

In one embodiment, the web crawler 304 may browse and search through user-generated posts across various online platforms. The web crawler 304 may extract the text of each user-generated post and provide the information to a content analysis classifier 310 to determine whether a specific post contains statements disputing the credibility of a shared video.

In one embodiment, the content analysis classifier 310 may be a binary text classifier that takes various features as inputs to classify the user-generated posts into two categories: the posts that challenge the credibility of a shared video, and the posts that do not. The various features may include negative sentiment towards the video, and certain phrases or words used that could be indicative of a challenge to credibility (e.g., “fake,” “manipulated,” “edited,” “unauthentic,” etc.).

In one embodiment, the entity extractor 308 may process the text of a user-generated post to extract key entities, upon determining that the post contains assertions that challenge the credibility of a shared video. The extracted key entities may include a link to the shared video, a link to a video that the user believes is original and unedited (also referred to in some embodiments as a reference video), cue-points in the timeline of the shared video the user identifies as being manipulated, tags or topics associated with the post. In one embodiment, the extracted key entities and their respective values may be saved in storage 615. In some embodiments, the extracted key entities and their respective values may be saved in a remote database 250 that connects to the computing system 600 via a network, as illustrated in FIG. 2.

In one embodiment, the hash sequence creator 320 may generate a unique fingerprint or signature of a shared video (that is being challenged of being fake) and/or an reference video using a hash function. In some embodiments, the hash function utilizes a perceptual hashing algorithm, which is designed to generate similar hash values for images or frames that are similar. In some embodiments, the hash sequence creator 320 may first create a set of sampling frames for the shared video. The creation of a set of sampling frames may involve extracting individual frames from the shared video at a defined interval. For example, if the shared video has a frame rate 20 fps (frames per second), and it is determined to sample the video every second, the hash sequence creator 320 may extract every 20^{th} frame of the shared video. The extracted sampling frames are then arranged according to the timeline of the shared video, and each represents a distinct point in time within the video. After the set of sampling frames is created, the hash sequence creator 320 may hash each sampling frame to create a specific hash value. The hash values collectively represent a signature or fingerprint of the shared video.

In one embodiment, the hash sequence overlapping locator 342 may retrieve the fingerprint of a reference video from the storage 615 or database 250, and compare it with the fingerprint of a shared video to determine if there exists any overlapping clips between the two videos, even if the shared video has been slightly modified. In some embodiments, the identification of overlapping clips may be performed by comparing the similarity between the hash values of each sampling frame in the shared video with its corresponding frame in the reference video. In some embodiments, the similarity between two hash values may be calculated using a distance metric, such as cosine similarity or Euclidean distance.

In one embodiment, the video reader 324 may access and retrieve a video based on the video's web link (e.g., URL). In one embodiment, the audio extractor 330 may process a video to extract the audio track within the video. In one embodiment, the speech-to-text module 338 may convert the audible content within the audio track into a transcription.

In one embodiment, the audio/visual consistency check module 340 may check the consistency between the video and audio of a shared video. By processing the audio track of the shared video, the audio/visual consistency check module 340 may identify syllables in the speech of the shared video and the time points at which each syllable is spoken. Based on the identified syllables and their respective time points, the audio/visual consistency check module 340 may compare each syllable with its adjacent (or corresponding) video frame(s), and generate a consistency value indicating the degree of consistency between each syllable and its adjacent (or corresponding) video frame(s). In some embodiment, the comparison between the extracted syllables and their corresponding video frames may be performed using machine learning models.

In one embodiment, the video frame slicer 328 may process a shared video to create sampling frames at a defined interval. The video property analysis module 336 may then analyze each sampling frame and its corresponding CV properties to determine whether the sampling frame has been manipulated. In some embodiments, the video property analysis module 336 may comprise a lowpass filter that removes frames with high frequency noise or fluctuations in the CV properties of the shared video (also referred to in some aspects as occasional, fleeting glitches in the shared video). For example, a camera error may cause the lighting property of a frame changing drastically. The frame may be removed by the lowpass filter. As such, the video property analysis module 336 may avoid false positive results in the modification detection process.

In some embodiments, the video property analysis module 336 may comprise machine learning model(s) that takes the CV properties and their corresponding values as inputs to predict whether a sampling frame has been modified or edited. In one embodiment, the output of the machine learning model(s) may be a binary classification, indicating whether a frame has been manipulated. In another embodiment, the output of the machine learning model(s) may be a numerical value that indicates the degree of confidence that a certain frame has been manipulated.

In one embodiment, the timestamp synchronizer 358 may synchronize the predicted classifications generated by the video property analysis module 336 and the consistency values generated by the audio/visual consistency check module 340 with the cue-point(s) 312 indicated within user-generated post(s).

In one embodiment, the video authenticity validation module 360 may process four data streams as inputs to determine the authenticity of a shared video. The four streams may include the cue-point(s) indicated within user-generated post(s), the predicted classifications generated by the video property check module, the consistency values generated by the audio/visual consistency check module, and the overlapping clips identified by hash sequence overlapping locator 342. In some embodiments, the video authenticity validation module 360 may assign a specific weight to each type of stream. The video authenticity validation module 360 may summarize the four streams along with their assigned weights, and compare the result with a defined threshold. If it is determined that the result is above the threshold, the module may categorize the shared video as a fake video.

In the illustrated example, the storage 615 may include tags and topics extracted from user-generated posts and/or the speech of the shared video, web link to the shared video, fingerprint of the shared video, web link to the reference video, fingerprint (hash values) of the reference video, fingerprint of the reference video, transcription(s) of the shared video, cue-point(s) indicated within user-generated posts, and the like. In some embodiments, as depicted in FIG. 2, the aforementioned information may be saved in a remote database 250 that connects to the computing system 600 via a network 210.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

While the foregoing is directed to embodiments of the present invention, other and further embodiments of the invention may be devised without departing from the basic scope thereof, and the scope thereof is determined by the claims that follow.

What is claimed is:

1. A method comprising:
accessing a statement asserting that a video is fake;
identifying one or more characteristics of the statement, wherein the one or more characteristics comprise at least one of source information for the video, source information for a reference video, or one or more timestamps in the video;
performing consistency checks between audio and video of the video;
examining one or more video features of the video to detect modifications;
identifying overlapping clips between the video and the reference video; and
determining that the video is fake based at least in part on the one or more characteristics of the statement, the consistency checks, the video features, and the identified overlapping clips.

2. The method of claim 1, further comprising synchronizing the consistency checks, the video features, and the identified overlapping clips with the one or more timestamps within the video identified by the statement.

3. The method of claim 1, wherein the statement further comprises one or more tags describing contents of the video.

4. The method of claim 1, wherein accessing the statement alleging that the video is fake comprises analyzing texts within the statement using a binary classifier.

5. The method of claim 1, wherein performing the consistency checks between audio and video of the video comprises:
extracting audio track of the video;
converting the audio track into a sequence of syllables, wherein the sequence of syllables comprises a plurality of syllables that are spoken at different time points within the video;
processing the video to create a plurality of sampling frames, wherein each respective sampling frame, of the plurality of sampling frame, is captured at a time point that a respective syllable is spoken; and
comparing each respective syllable, of the plurality of syllables, with each respective sampling frame, of the plurality of sampling frames, to generate a plurality of consistency values.

6. The method of claim 5, wherein the plurality of consistency values is mapped onto a timeline, with each respective value represents a degree of consistency between the audio and video of the video at a time point that a respective syllable is spoken.

7. The method of claim 1, wherein examining the one or more video features of the video to detect modifications comprises:
processing the video to create sampling frames at a defined interval;
analyzing each of the sampling frames to extract the one or more video features using one or more image processing algorithms, wherein the one or more vide features comprise at least one of (i) pixilation, (ii) shadows, (iii) colors, (iv) edges, or (iv) textures; and
determining the video has been manipulated based on processing the one or more video features using a machine learning model.

8. The method of claim 7, wherein analyzing each of the sampling frames to extract the one or more video features further comprises passing outputs of the one or more image processing algorithms into a lowpass filter to remove high frequency noise in the extracted one or more video features.

9. The method of claim 1, wherein identifying the overlapping clips between the video and the reference video comprises:
processing the video to create sampling frames at a defined interval;
hashing the sampling frames to generate a signature for the video;
retrieving a signature for the reference video from a database; and
comparing the signature for the video with the signature for the reference video to identify the overlapping clips between the video and the reference video.

10. The method of claim 9, wherein retrieving the signature for the reference video from the database further comprises:
extracting one or more tags from the statements;
converting audio track of the video into written texts using one or more speech-to-text algorithms;
identifying one or more key entities from the written texts representing topics of the video; and
retrieving the signature for the reference video from the database based on the extracted tags and the identified key entities.

11. A system, comprising:
one or more computer processors; and
one or more memories collectively containing one or more programs which when executed by the one or more computer processors performs an operation, the operation comprising:
accessing a statement asserting that a video is fake;
identifying one or more characteristics of the statement, wherein the one or more characteristics comprise source information for the video, source information for an reference video, and one or more timestamps in the video;
performing consistency checks between audio and video of the video;
examining one or more video features of the video to detect modifications;
identifying overlapping clips between the video and the reference video; and
determining that the video is fake based at least in part on the one or more characteristics of the statement, the consistency checks, the video features, and the identified overlapping clips.

12. The system of claim 11, wherein the operation further comprises synchronizing the consistency checks, the video features, and the identified overlapping clips with the one or more timestamps within the video identified by the statement.

13. The system of claim 11, wherein performing the consistency checks between audio and video of the video comprises:
extracting audio track of the video;
converting the audio track into a sequence of syllables, wherein the sequence of syllables comprises a plurality of syllables that are spoken at different time points within the video;
processing the video to create a plurality of sampling frames, wherein each respective sampling frame, of the plurality of sampling frame, is captured at a time point that a respective syllable is spoken; and
comparing each respective syllable, of the plurality of syllables, with each respective sampling frame, of the plurality of sampling frames, to generate a plurality consistency values.

14. The system of claim 11, wherein examining the one or more video features of the video to detect modifications comprises:
processing the video to create sampling frames at a defined interval;
analyzing each of the sampling frames to extract the one or more video features using one or more image processing algorithms, wherein the one or more vide features comprise at least one of (i) pixilation, (ii) shadows, (iii) colors, (iv) edges, (iv) textures; and
determining the video has been manipulated based on processing the one or more video features using a machine learning model.

15. The system of claim 11, wherein identifying overlapping clips between the video and the reference video comprises:
processing the video to create sampling frames at a defined interval;
hashing the sampling frames to generate a signature for the video;
retrieving a signature for the reference video from a database; and
comparing the signature for the video with the signature for the reference video to identify the overlapping clips between the video and the reference video.

16. A computer program product comprising one or more computer-readable storage media collectively containing computer-readable program code that, when executed by operation of one or more computer processors, performs an operation comprising:
accessing a statement alleging that a video is fake;
identifying one or more characteristics of the statement, wherein the one or more characteristics comprise source information for the video, source information for an reference video, and one or more timestamps in the video;
performing consistency checks between audio and video of the video;
examining one or more video features of the video to detect modifications;
identifying overlapping clips between the video and the reference video; and
determining that the video is fake based at least in part on the one or more characteristics of the statement, the consistency checks, the video features, and the identified overlapping clips.

17. The computer program product of claim 16, wherein the operation further comprises synchronizing the consistency checks, the video features, and the identified overlapping clips with the one or more timestamps within the video identified by the statement.

18. The computer program product of claim 16, wherein performing the consistency checks between audio and video of the video comprises:
extracting audio track of the video;
converting the audio track into a sequence of syllables, wherein the sequence of syllables comprises a plurality of syllables that are spoken at different time points within the video;
processing the video to create a plurality of sampling frames, wherein each respective sampling frame, of the plurality of sampling frame, is captured at a time point that a respective syllable is spoken; and
comparing each respective syllable, of the plurality of syllables, with each respective sampling frame, of the plurality of sampling frames, to generate a plurality of consistency values.

19. The computer program product of claim 16, wherein examining the one or more video features of the video to detect modifications comprises:
processing the video to create sampling frames at a defined interval;
analyzing each of the sampling frames to extract the one or more video features using one or more image processing algorithms, wherein the one or more vide features comprise at least one of (i) pixilation, (ii) shadows, (iii) colors, (iv) edges, (iv) textures; and
determining the video has been manipulated based on processing the one or more video features using a machine learning model.

20. The computer program product of claim 16, wherein identifying overlapping clips between the video and reference video comprises:
processing the video to create sampling frames at a defined interval;
hashing the sampling frames to generate a signature for the video;
retrieving a signature for the reference video from a database; and
comparing the signature for the video with the signature for the reference video to identify the overlapping clips between the video and the reference video.
